(19) United States
(12) Patent Application Publication
(10) Pub. No.: US 2003/0163525 A1
(43) Pub. Date: Aug. 28, 2003

(54) Ink instant messaging with active message annotation

(75) Inventors: Ferdinand Hendriks, Lavoie Court (NL); John P. Karidis, Ossining, NY (US); Gregory F. Russell, Yorktown Heights, NY (US); Zon-yin Shae, South Salem, NY (US); Xiping Wang, Putnam Valley, NY (US)

Correspondence Address: SCULLY, SCOTT, MURPHY & PRESSER, 400 Garden City Plaza, Garden City, NY, 11530, US

(73) Assignee: International Business Machines Corporation, Armonk, NY

(21) Appl. No.: 10/081,941

(22) Filed: Feb. 22, 2002

(51) Int. Cl. G06F 15/16

(52) U.S. Cl. 709/204

(57) ABSTRACT

A system and method for allowing handwritten information messaging among users of interconnected computers. Information content, including text and handwritten stroke information, is presented to the user in a graphical user interface (GUI) provided on a user's computer system. The messaging method provides for multimedia, handwritten and text messaging. The non-text data is layered among the usual text messages, after having been suitably scaled and repositioned. Additionally, the present invention provides for annotation, modification and deletion of items presented anywhere in an Instant Messaging record. Users are alerted to annotations by hyperlinks. The method is adapted for use with Personal Digital Assistants (PDA's) as well as other type clients. The method includes a late join feature, allowing users connecting to an IM session already in progress access to the complete record of the IM session. Ink and text input on predefined business forms displayed to the user are also permitted.

### FIELD OF INVENTION

The present invention relates to the field of computer electronic collaboration through means of a real time messaging system. More specifically, the present invention is directed to a system and method for annotating logs of messages by using handwritten strokes, i.e., electronic ink, on a device such as a Personal Digital Assistant (PDA) that has established a connection to a real time messaging service.

### BACKGROUND

Instant messaging (sometimes called IM or IMing) is the ability to easily see whether other users are connected to the Internet and, if they are, to exchange messages with them. Instant messaging differs from ordinary e-mail in the immediacy of the message exchange and also makes a continued exchange simpler than sending e-mail back and forth. Most instant messaging exchanges are text-only. However, some services allow attachments. A record, usually called a chat record, i.e., text log, or IM record, grows as the message exchanges continue. In current systems, once a message reaches the chat record, that message cannot be annotated.

The concept of instant messaging began with Unix commands such as “who” and “talk”, which allow users to see who is available as a communications partner, and to communicate messages nearly instantly. Instant messaging has evolved to run on numerous computer systems, including Windows®, and is used more and more as a replacement for e-mail, and as a “control channel” among remote users running another collaborative application.

An early protocol developed for instant messaging is Internet Relay Chat (IRC). Popular IM services are AOL Instant Messenger (AIM), ICQ, and Microsoft Instant Messenger. Many other IM services such as Everybuddy and webdiving are also available. There are a growing number of enhancements to IM such as Moncreif et al (U.S. Pat. No. 6,061,716) which describes a system for combining IM with live video reception. The system described in Moncreif, allows users to chat about video material presented to their graphical user interfaces (GUI's). However, the Moncreif system, and all of the previously mentioned systems lack the capability for merging text, electronic ink and annotation of the chat record.

Despite the incompatibility of different proprietary IM protocols, IM is enjoying very robust growth. To participate in IM, users must typically register and be authenticated by an IM service. In its basic form, users send short text messages either via the server (client server model) or directly to each other (peer-to-peer model). IM networks may contain more than one server. The messages may contain ancillary information such as a nick name and a timestamp. IM may support “Chat” which is an electronic meeting place usually organized by topic. There will also be a list of people available for communication, often referred to as a buddylist, possibly including their status including, but not limited to on-line, and away status. The IM server may record the IM session allowing each client user to locally save a copy of the session. A typical record, sometimes called history, would include a sequence of lines of text.

IM is currently available for use on many personal digital assistants (PDA's), such as Palm®, Compaq IPAQ®, and others. PDA's are not large enough to have physical keyboards, and their display screens are quite limited compared to those of desktop and laptop computers. The preferred modes of data input to PDA devices are handwriting with a stylus, or selecting individual characters with a stylus, using a virtual or software-defined keyboard which is somewhat slow and cumbersome, although shortcuts and predefined phrases may help to speed up frequently used tasks. A stylus produces stroke information, sometimes referred to as electronic ink, or simply “ink”. Stroke input is, at the minimum, stored as an ordered set of quantized pen locations, but may include many more attributes such as the time at which each location was visited, the pen pressure and pen inclination, userid of the pen, userid of the writer and others.

Despite the fact that “ink” is arguably the oldest method of data entry for handheld devices such as PDA's, standardization efforts have lagged. There is renewed interest in standardization by the world wide web consortium (W3C), owed in part to the increasing importance of handheld devices such as the Palm®, Compaq IPAQ®, Handspring Visor® and others. Ink input is entered in a very natural way on PDA's, while entering text is more awkward. Other modalities such as speech and gesture also solve some of the problems associated with the lack of a keyboard, but due to a lack of processing power, the predominant data type for input is still text.

The fact that text is still predominant presents an additional problem of expressing emotional content of a message. To solve this problem many systems allow a number of pre-defined icons, often called emoticons, allowing users to attach the emoticons to the users' messages. A familiar example of an emoticon is a smiley face picture. However, since the emoticons are predefined, unnatural limitations on message emotional content still exist. Thus the current state of IM lacks the emotional expression that handwritten stroke input can provide.

Additionally, IM session records are static, i.e., current state of the art computer instant messaging logs are passive areas of text for networked computer users to read. These passive areas of text cannot be used for annotation, and thus the communications options that networked instant messaging computer users have are limited. PDA IM'ers are thus wanting for a solution to the abovementioned shortcomings of current IM systems.

Thus, it would be highly desirable to overcome the shortcomings of instant messaging presented above, by providing handwritten stroke information to an instant messaging system. It would further be highly desirable to provide the capability of chat record annotation using handwritten stroke information within the instant messaging system.

### SUMMARY OF THE INVENTION

Therefore, it is an object of the present invention to provide a method to activate the text log areas and create within the active text log area an “ink” message.

Another object of the present invention is to provide a method allowing networked instant messaging (IM) users to view the ink message in real time.

A further object of the present invention is to provide a method for alerting all or a specific set of participants in a chat room to notice the annotation messages, i.e. handwritten stroke information.

Another object of the present invention is to provide a method for compressing, i.e. downsampling the handwritten stroke annotations in a manner that allows a chat record of the annotations to remain intelligible so that users may still visually recognize the annotations.

These and other objects and advantages may be obtained in the present invention by providing a method for inputting handwritten stroke information into a chat record of an instant messaging system, and permitting handwritten stroke information annotation of the record, while alerting, i.e., notifying users of the system that the annotation record is viewable on their graphical user interfaces.

Specifically the method for handwritten stroke information input, annotation and displaying comprises: establishing a connection to a messaging service; inputting handwritten stroke message objects into a current message; transmitting the current message to the messaging service, wherein the messaging service keeps a record of all said current messages for distribution to and handwritten stroke annotation by the messaging service users.

### BRIEF DESCRIPTION OF THE DRAWING

The present invention will now be described in more detail by referring to the drawings that accompany the present application. It is noted that in the accompanying drawings like reference numerals are used for describing like and corresponding elements thereof.

FIG. 1 is a flow diagram of the steps taken by a user of a preferred embodiment of the present invention;

FIG. 2 is a screenshot of a combination of text and ink chat created by the preferred embodiment of the present invention;

FIG. 3 shows the graphical user interface (GUI) fields of a client application window in the preferred embodiment of the present invention;

FIGS. 4A and 4B show the user interface, including the recording field and its position in the entire IM record;

FIGS. 5A, 5B, and 5C, show annotation with hyperlinks, providing quick jump to and from an annotation (State transitions, required for an IM session which includes an annotation link, are shown in FIG. 5D);

FIG. 6 shows the graphical user interface with a predefined form that accepts stroke and text-based response to prompts in the predefined form;

FIG. 7 shows the screen areas segmented into different text and ink areas;

FIG. 8 shows a GUI of a preferred aspect of the present invention that incorporates a timeline field; and,

FIG. 9 shows an interconnected network of computers in which the present invention provides messaging between them.

### DETAILED DESCRIPTION OF THE PREFERRED EMBODIMENT

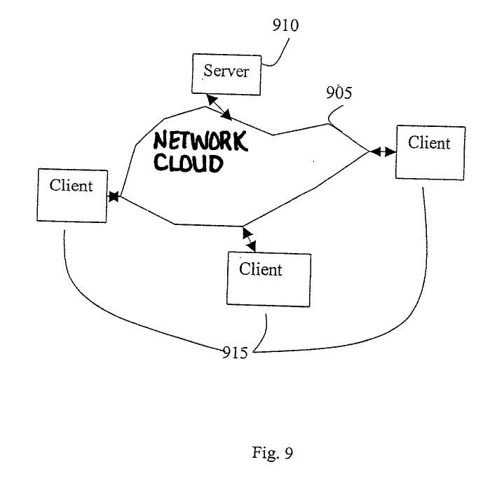

A preferred embodiment of the invention is based on a client/server architecture, and is implemented in personal Java® (by Sun Microsystems) on a Personal Digital Assistant (PDA), such as the Compaq IPAQ®, running under the Microsoft Windows CE® operating system. Clients 915, such as shown in FIG. 9, are connected to a network cloud 905, which may be, for example, the Internet. A typical client application may require users to register with a server 910. Additionally, the client application may make use of Lotus Sametime® 2.0 Java Toolkit services such as:

Community Service for implementing login and awareness;

Domino Distributed Internet Architecture (DNA) Service for implementing directory access authentication; and HTTP service.

In a messaging service, the notion of awareness, which is often implemented as a buddylist, allows a client to see other clients in the same group. It is known in the art that grouping or clustering of clients often uses a “room” metaphor. This is similar to the notion of “place” under Lotus Sametime®. In addition to the identity of registered users in the same room, their status is also reported. For example, a green square presented next to a buddylist client via a GUI might indicate that the client in question is Active, whereas a red square might indicate that the client in question is away, etc.

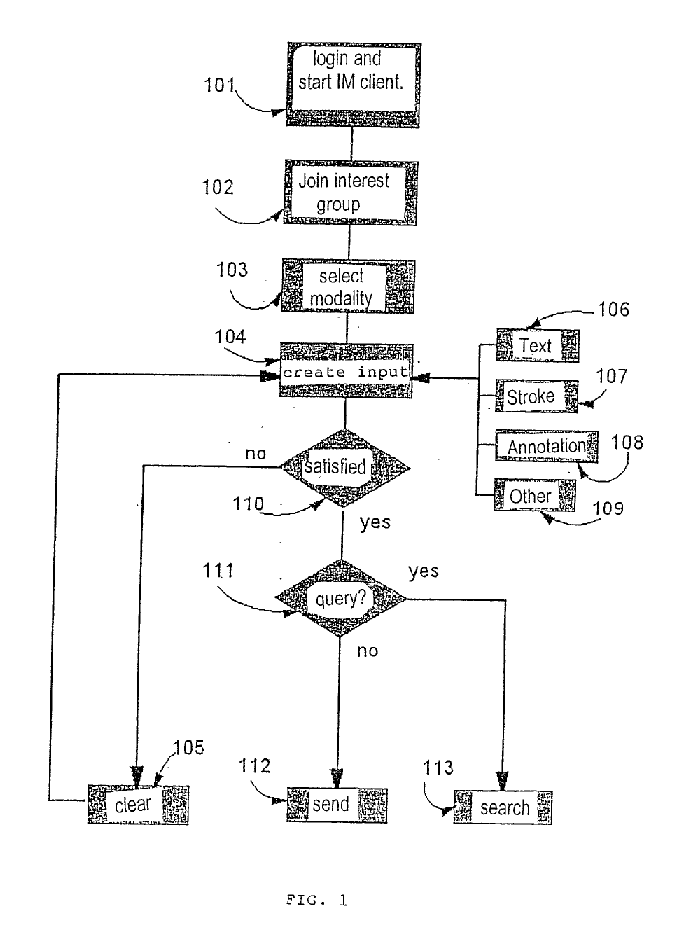

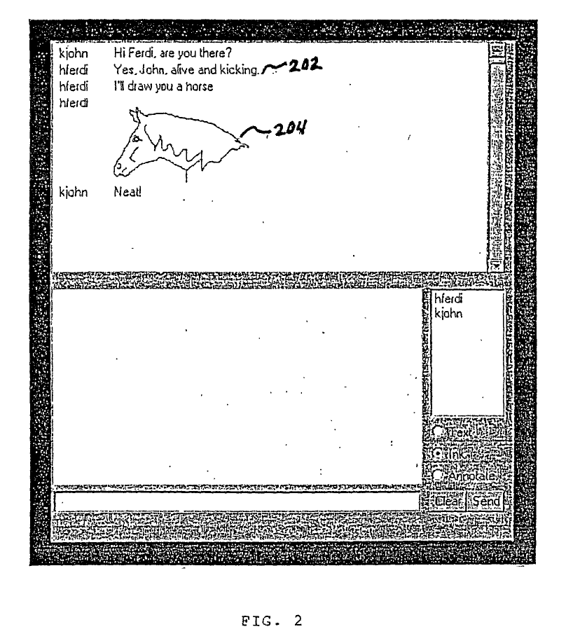

FIG. 1 illustrates the preferred steps executed at the client. At step 101 the IM client is started, establishing a connection to a messaging service. This start process includes login and authentication by the server of at least one of all the users of the messaging service. Subsequent to login and authentication, the user joins an instant messaging topic of interest at step 102. If a session for that interest group is in progress, the user is presented with the most recent message or messages. In addition, the messages may contain predefined message objects such as forms that can be filled out. The user may contribute to the IM session by creating input at step 104, in various modalities, which may be selected as shown at step 103. Modalities include text 106, stroke 107, annotation 108, and other multimedia objects, 109 such as audio and video. Input may also be inserted via cut and paste from other applications. Input accepted through any of the above mentioned modalities is in the form of a message object which becomes part of a current message that is contained by a current record. This current record is an Instant Messaging record in a preferred embodiment of the present invention. Deleting the input is supported as shown at step 105 which is labeled “clear”. If the user is satisfied with the input which is buffered at the client at stage 110, the user can signal whether the input is to be interpreted as a query at step 111 using the input as key object. If the input represents a query the input is sent to the server for searching at step 113, otherwise the input is sent to the server to be stored in the IM record, as shown at step 112. The server keeps a record of all current messages in object oriented form and redistributes the input to the networked session participants. The IM record comprises IM objects that are ordered temporally. The IM objects are rendered in the recording field for viewing by the user. FIG. 2 is an illustration of an example IM session which includes a combination of text entries 202 and an ink, i.e., handwritten stroke information 204, as rendered in the recording field for viewing.

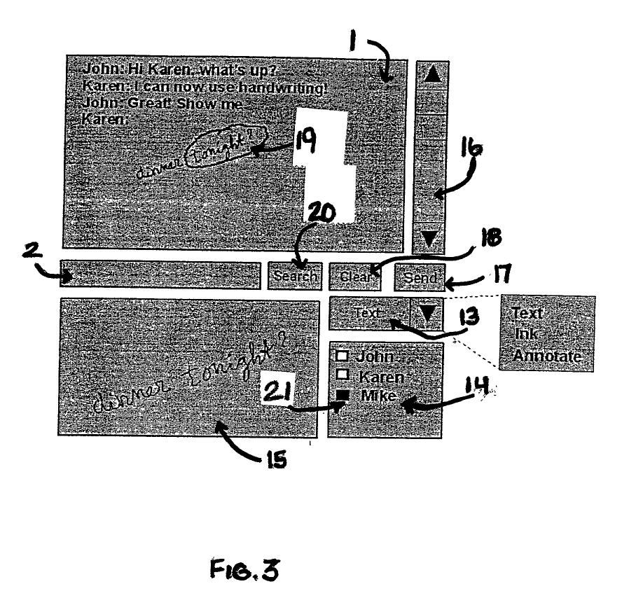

For a given messaging session, the inventive method provides the client application window of FIG. 3. Referring to FIG. 3, it is shown that the client application window is divided into areas including a private ink area, i.e., handwritten stroke input field 15 in which the user may locally preview a message. Additionally, an awareness field 14 is provided, wherein registered users and their statuses are shown. The client application window further includes a scrollable selector 13 for selecting the modality of input types including text, ink, annotation, or other multimedia objects. A text input field 2 is also provided for entry of text to be associated with a message object. The client application window also comprises a send button 17 which causes current messages input to be transmitted to a messaging service for distribution to all participants in the session. Further, a clear button 18 provides a means for clearing the input areas. A public recording field 1 enabling input of public messages comprising text, ink and annotation is provided. The recording field also includes a scrollbar 16 for scrolling through the public messages. The example annotation 19 shown in FIG. 3 is written directly into the recording field. A search button 20 is provided for initiating searches based on a user query input. Additionally awareness icons 21 associated with each of the participants are provided for expressing each participant's status in awareness field 14.

Referring again to the scrollable selector 13 of the client application window, the message types capable of being entered by a user are not limited to the types shown in FIG. 3. The scrollable selector 13 may provide support for other modalities such as, for example, audio and video objects. The scrollable selector 13, i.e., modality selector, may explicitly classify the type of data entered in the Instant Messaging (IM) record. This type classification is a form of metadata associated with the object, and is useful for browsing and retrieval of objects in the IM record. Implicit classification of data type entered, i.e., specifying the input data type without using the scrollable selector 13 is automatically provided in response to a user clicking in the private ink input field 15, the text input field 2 or the annotatable recording field 1. More particularly, the awareness field 14 of the client application window is a standard component of most IM systems. As shown in the example client application window of FIG. 3, the awareness field 14 comprises the names of those logged in to the same IM session with corresponding awareness icons 21 which have meanings such as, for example, “I am logged in”, “I am away”, “Do not disturb”, etc., and, may also comprise a timestamp (not shown) for tracking chronology associated with the field entries.

As mentioned, private ink input field 15 presents a preview buffer for stroke input and other IM objects for input, providing the capability for users to preview the objects before transmission. The present invention provides geometric transformation for objects in this field that are displayed in recording field 1. This geometric transformation provides for more compact, i.e., compression of non-textual IM objects such as ink, annotation, or other multimedia objects. Geometric transformations provided by the current invention include affine and perspective transformations.

As further shown in FIG. 3, “Clear” 18 and “Send” 17 buttons work as follows; the “Clear” button clears the last entered input object; the “Send” button causes the input to be sent to the server for distribution among session participants and storage in the IM record. If the IM record already exists prior to the “Send” operation, the handwritten stroke information is appended to the existing record.

Additionally, a user can annotate the recorded IM session with ink, which may be of a different color compared with ink entered in the ink input area. Annotations may also be general multimedia objects.

Ink input visual compression of new user input added at the bottom of the recording field is achieved by reducing the size of the electronic ink input, and left justifying and arranging the ink as a graphical strip among other graphic strips and/or text messages. Another compression technique involves scaling the stroke input from large to small depending on its age, such that, for example, recent input is more visible than older input.

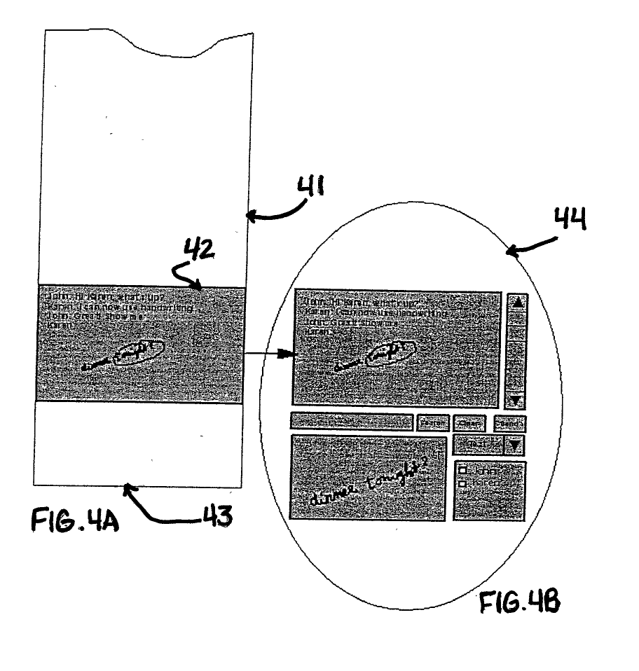

The recording field 1 of the present invention further provides a scroll metaphor to the user such that the entire scroll is accessible to users as if it were a whiteboard of continuously increasing length as a session progresses. Annotations entered in the recording field are public and distributed to all users. It is understood that besides text and ink, other media types such as, for example, images, video and audio files are supported by and may be inserted into the recording area. The public recording field 1 provides a viewport 42 of a logical recording strip which may be very long (See FIGS. 4A and 4B). The recording area 41 logically represents the contents of all that has been entered into the session. New content is added at the bottom of this area. The Graphical User Interface (GUI) provides the user with the impression that the user is looking at part of a very elongated strip of constant width through the viewport 42. In an alternative embodiment, the user is provided with a viewport that has a variable width and a horizontal slider for left-right scrolling in the recording display. An example of the full GUI of FIG. 3 is shown in FIG. 4B at reference numeral 44 including the contents of the public viewport 42.

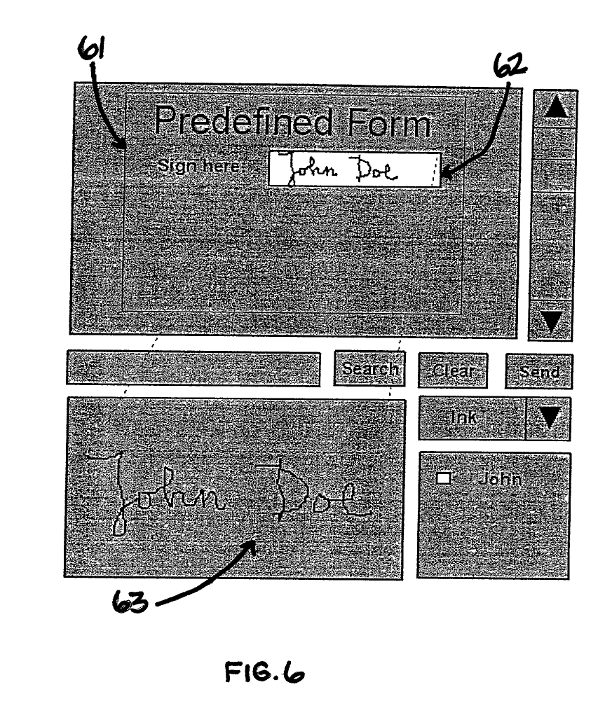

A predefined form function of the present invention provides the capability for a user to fill in the predefined form 61 with text and/or electronic ink. FIG. 6 provides an example of a predefined form IM client 61. A recording field may hold the predefined form(s) upon session entry. The user then may fill out the form by:

1. selecting the form as a message object which may contain a URL, i.e., hyperlink;

2. selecting the field to be filled in by clicking on the field of interest, for example, the John Doe entry 63, where the predefined form is segmented with each segment having its own specific meaning, and the application program detects that the field was selected and awaits user input, e.g., a signature;

3. by writing the information to be filled in on the form by writing in the user input area 15 for electronic ink as shown 63, or by typing into the text input area, or by pasting an object from another application;

4. by pressing the send button; and,

5. by repeating steps 1,2,3 upon error, if necessary, wherein the current message objects will be overwritten.

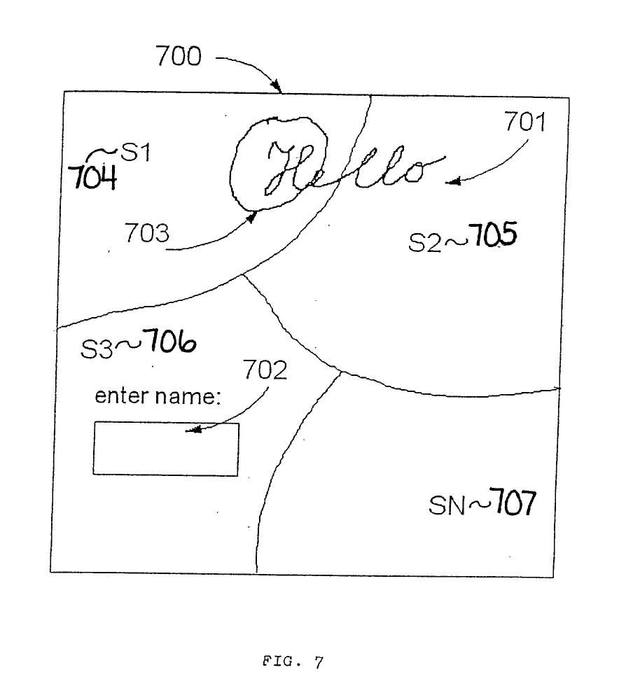

Electronic ink input is scaled and repositioned in such a way that it fits the user input areas 62 of the predefined form 61. Textual or handwritten stroke information entered into the input fields is associated with an object. Objects generally reside on the server. A segmented object as shown in FIG. 7 is what a user would see when viewing the object in the recording field. The actual object resides on the server. The stroke “Hello” 701 overlays the segmented object 700 and is segmented by regions S1 and S2. The present invention provides answers to such queries as, for example; show the segment of object 700 that lies in S1 and locate the stroke media in question. The invention also has the capability to report a pointer to an object. Object 700 in general contains a URL, i.e., hyperlink, (not shown), which in turn may point to segments S1 through SN, having their own URL's.

A semantics description file contains the meaning of IM objects such as object 700. The semantics description file also associates text or stroke input into region 702 with the meaning “name”. If an annotation 703 is entered, the system can interpret the annotation as a query on the underlying IM object. For example, annotation 703 can cause the system to return just that part of the “Hello” stroke that is encircled by the annotation, 703, thus performing a media locator service. Preferably the emerging MPEG-7 standard is used for a systematic way to describe the multimedia content of IM sessions so that browsing and querying become much more efficient.

Stylus locations are reported in binary format, compressed or uncompressed. While compression of handwritten strokes is known in the art, the current invention practices an improvement known as progressive scalable stroke compression. Progressive transmission of stroke information allows a user to gain an early visual impression of the strokes, while refinements are sent later. In order to accomplish this progressive stroke information transmission several approaches, such as wavelet decomposition, the Douglas Peucker method, the Lempel-Ziv technique, etc, may be employed. All stroke and other media types may also be encrypted and watermarked.

The late join function provides a means for clients who join an ongoing IM session to have access to complete histories of the session that accumulated until they joined. The server assures consistency of the IM record among the users that look at the same view of the record. The recording field 1 can be modified by any participant. Updates are needed if the participant views a section of the record that has been updated (usually the most recent part of the record). The server is provided with a means to update information displayed in the viewport of each user.

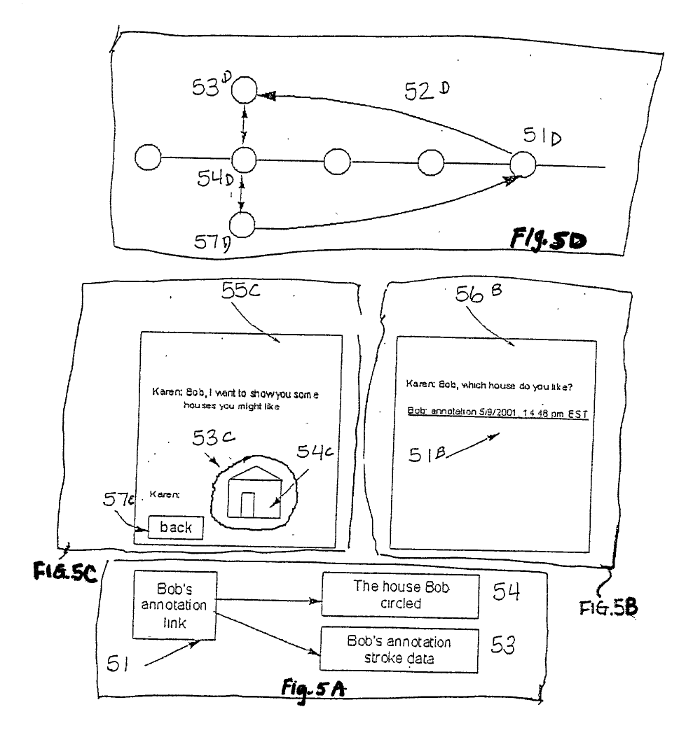

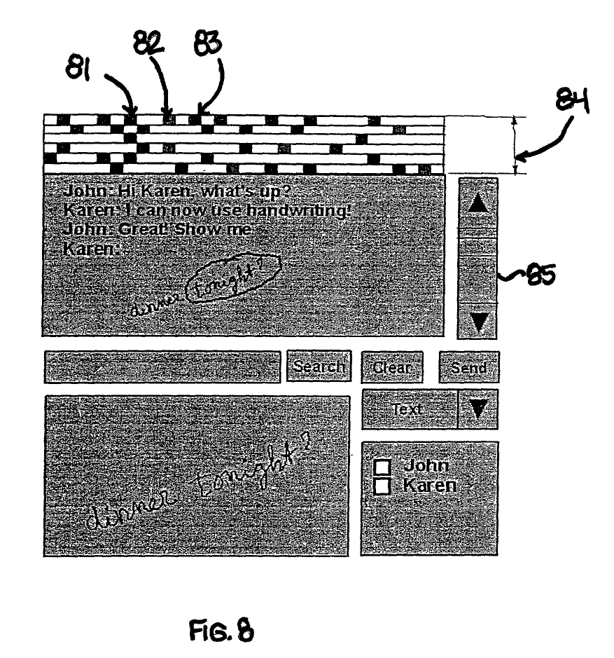

The archive function provides a means for clients to store each message as an object which can contain other sub-objects. Objects may contain or may themselves be URL's, i.e., hyperlinks that point to the actual location of the data to which the object refers. Navigational aids enable quick access to the recorded data both sequentially, using a scrollbar (FIG. 3, reference numeral 16), as well as via random access, using a timeline field (FIG. 8, reference numeral 84). The recording field shows message objects comprising text, stroke input, stroke annotations, text entries that are hyperlinks to earlier recorded stroke annotations as shown in FIGS. 5A, 5B, ad 5C. FIG. 5A shows the relationship between the annotation link and the action that Bob has taken, entering the annotation stroke data. The corresponding view that a user would see as an alert to the annotation is shown in FIG. 5B. The view that a user would see after selecting the annotation hyperlink is shown in FIG. 5C. FIG. 5D at step 52D shows the transition from the hyperlink to Bob's annotation stroke data 53D. Finally, general multimedia objects that may have been pasted into the recording field 1 are displayed, as shown in FIG. 5C at 53C and 54C. As an example, a user is allowed to copy and paste a bitmap into the user input area, and by clicking “send” add it as a message object into the record. Any number current messages may be created by this copy and paste method.

Timeline/Search functionality provides for searching the recorded IM session by user selected criteria including timeline and content searching. Features such as skip to beginning/end, search by content may be included as part of the user interface. The input area may also serve as an input query area in order to query the recorded messages by content. FIG. 8 shows an embodiment of the client graphical user interface where some of the public recording area has been reserved to implement a “layered time line”. The frame shows the local user's text as a mark 81, text from others as mark 83 and annotations (from anyone) as mark 82. Clicking on a mark causes the recording frame to show a section of the record corresponding to that mark (either ending at the mark or beginning at the mark). The frame shows a timeline broken in sections, such that each section forms a layer. The intent is that frame 84 represents the whole instant messaging session. Distance along each layer represents an elapsed amount of time. Preferably the time is measured linearly and uniformly along each layer. However, especially when the session is particularly long, the distance may be measured non-linearly along each layer. For example exponential measurement allows a great increase in the information content of the timeline frame 84, however at the expense of readability of the oldest items. The timeline frame 84 allows the user random access to the recorded material, while the scrollbar 85 allows sequential access. It will be understood that the marks of the timeline could themselves be icons that are specific for the modality of the input entered.

Hyperlink functionality provides for a method by which pointers such as a URL are stored to the actual data describing an object (All IM messages are objects, i.e., an object-oriented description of an abstract or concrete entity having attributes, methods and so on). Through the use of hyperlinks, i.e., URL's, provided by the current invention, a user may navigate to the desired message object for annotation within the message record. Thus, the present multimedia IM system of this invention allows a user to make stroke based annotations anywhere in the recording field. An annotation may or may not be associated with an earlier message. If an association is intended, the user is required to select the message to be annotated, for example by clicking on it. For example, item 54C in FIG. 5C is to be annotated by Bob. Bob selects 54C indicating that the house will be the target for his annotation. He then enters the annotation 53C. Message object 54C is now linked to, i.e., associated with annotation 53C which is added as a new handwritten stroke information message object to the current session record. The message contained in message object 54C is visible to the user as a bitmap of a house, but the message object may contain many attributes, such as cost, age, number of rooms, etc. In addition to the annotation message object 53C, a “back link” 57C is added to annotation 53C. To facilitate navigation in the recording field 1, entering an annotation 53C causes an entry at the end of the IM record. This entry is a hyperlink (FIG. 5B at 51B) to the actual annotation, and is a message object in its own right. When clicked, it alerts other users to the fact that another user made an annotation somewhere in the public record. Without this feature, users other than the one making the annotation would not be alerted to annotations. Because a user can scroll to any place in the recording field, what each user sees is not necessarily always the most recent part of the IM session. In addition to the hyperlink in the recording field, the hyperlink 51B is also entered as a symbol at the end of the timeline frame (TF) 84. The actual annotation 53C also appears in the TF 84. The annotation can be associated with an earlier entry 54C. FIG. 5C illustrates a scenario in which a hyperlink is used to choose a picture of a house 54C. User Karen has entered several real estate listings on her PDA and has shown them to Bob. She then prompts Bob for the house that he likes best. Bob indicates his preference by scrolling to the house he likes stopping at view 55C and circling the house (stroke-based annotation 53C). Karen, if viewing the current view of the recording field immediately sees the hyperlink (FIG. 5B at 51B) on her screen. If she happens to be at a different view, she is still alerted via the new entry in the TF, which may flash to draw attention to it. To facilitate jumping back to the location in the record from which the annotation was reached, usually the end of the record, a “back” button 57C is added to the annotation 53C.

Now that the invention has been described by way of a preferred embodiment, various modifications and improvements will occur to those of skill in the art. For example, the program can alternatively be designed to run on a device with or without a keyboard or stylus. In another possible embodiment, human input is not in the form of stylus ink, but rather is in the form of by example, speech, and/or gestures. Accordingly the device used for IM would be equipped with the appropriate transducers capable of capturing speech and/or gesticulations. Thus, it should be understood that the preferred embodiment is provided as an example and not as a limitation. The scope of the invention is defined by the appended claims.

What is claimed is:

1. A method for messaging within an interconnected network of computers comprising:
establishing a connection to a messaging service;
inputting handwritten stroke information message objects into a current message;
transmitting said current message to said messaging service, wherein said messaging service keeps a record of all said current messages for distribution to, and handwritten stroke information annotation by, users of said messaging service.

2. The method for messaging as claimed in claim 1, wherein said message objects are IM objects; and said current message is an IM record.

3. The method for messaging as claimed in claim 1 further comprising copying a plurality of current messages from other applications.

4. The method for messaging as claimed in claim 1 wherein said messaging service is of a peer to peer type.

5. The method for messaging as claimed in claim 1, further comprising forwarding said handwritten stroke information to at least one participant.

6. The method for messaging as claimed in claim 1, further comprising appending said handwritten stroke information onto an existing said record.

7. The method for messaging as claimed in claim 1, wherein said establishing said connection is initiated by a first of a plurality of said users of said messaging service.

8. The method for messaging as claimed in claim 7, further comprising:
providing a graphical user interface for said user; and
said graphical user interface including a handwritten stroke input field.

9. The method for messaging as claimed in claim 8, wherein said graphical user interface comprises an awareness field.

10. The method for messaging as claimed in claim 8, wherein said graphical user interface comprises a text input field.

11. The method for messaging as claimed in claim 10, further comprising entering text into said text input field wherein said text is associated with said message objects for transmission to said messaging service.

12. The method for messaging as claimed in claim 8 further comprising entering handwritten stroke information into said handwritten stroke input field wherein said handwritten stroke information is associated with said message objects for transmission to said messaging service.

13. The method for messaging as claimed in claim 8, further comprising logging and displaying a complete history of said current messages in a recording field of said graphical user interface.

14. The method for messaging as claimed in claim 13, wherein any one of said current messages contains at least one URL for providing location information of an associated said message objects in said record.

15. The method for messaging as claimed in claim 14, wherein each of said plurality of users may navigate through said recording field to said associated said message objects by selecting said at least one URL whereby said associated said message objects are displayed to said user.

16. The method for messaging as claimed in claim 15, further comprising:
annotating of said messages in said recording field by any of said plurality of users; and
using said hyperlink for alerting said plurality of users of said annotation.

17. The method for messaging as claimed in claim 16, wherein said annotating comprises:
a) navigating to a desired said message object of said record;
b) selecting the desired said message to be annotated; and
c) adding new handwritten stroke information message objects to said record.

18. The method for messaging as claimed in claim 13, further comprising searching said record based on user selected criteria.

19. A computer program product comprising:
a computer usable medium having computer readable program code embodied therein for messaging within an interconnected network of computers, the computer readable program code in said computer program product comprising:
first computer readable program code for causing the computer to:
a) establish a connection to a messaging service;
b) input handwritten stroke information message objects into a current message;
c) transmit said current message to said messaging service, wherein said service keeps a record of all said current messages for distribution to, and handwritten stroke information annotation by, users of said messaging service.

20. The computer program product for messaging as claimed in claim 19, wherein:
said message objects are IM objects; and,
said current message is an IM record.

21. The computer program product for messaging as claimed in claim 19, further comprising computer readable program code for causing the computer to copy a plurality of current messages from other applications.

22. The computer program product for messaging as claimed in claim 19, further comprising computer readable program code for causing the computer to forward said handwritten stroke information to at least one participant.

23. The computer program product for messaging as claimed in claim 19, further comprising computer readable program code for causing the computer to append said handwritten stroke information onto an existing said record.

24. The computer program product for messaging as claimed in claim 19, comprising computer readable program code for causing the computer to allow said establishing said connection to be initiated by a first of a plurality of users of said messaging service.

25. The computer program product for messaging as claimed in claim 24, comprising computer readable program code for causing the computer to:
a) provide said user a graphical user interface;
b) include a handwritten stroke input field in said graphical user interface.

26. The computer program product for messaging as claimed in claim 25, comprising computer readable program code for causing the computer to provide an awareness field.

27. The computer program product for messaging as claimed in claim 25, comprising computer readable program code for causing the computer to provide a text input field.

28. The computer program product for messaging as claimed in claim 27, comprising computer readable program code for causing the computer to make text entered into said text input field a part of said message objects.

29. The computer program product for messaging as claimed in claim 25, comprising computer readable program code for causing the computer to make handwritten stroke information entered into said handwritten stroke input field a part of said message objects.

30. The computer program product for messaging as claimed in claim 25, comprising computer readable program code for causing the computer to provide a recording field in said graphical user interface for logging and displaying a complete history of said current messages.

31. The computer program product for messaging as claimed in claim 30, comprising computer readable program code for causing the computer to place in any one of said current messages at least one URL for providing location information of an associated said message objects in said record.

32. The computer program product for messaging as claimed in claim 31, comprising computer readable program code for causing the computer to provide each of said plurality of users the capability to navigate through said recording field to said associated said message objects by clicking on said at least one URL whereby said associated said message objects are displayed to said each of said plurality of users.

33. The computer program product for messaging as claimed in claim 32, comprising computer readable program code for causing the computer to:
provide the capability of annotation of said messages in said recording field by any of said plurality of users; and
alert said plurality of users of said annotation by said hyperlink.

34. The computer program product for messaging as claimed in claim 33, comprising computer readable program code for causing the computer to provide the following capabilities in said annotation:
a) navigation to a desired said message object of said record;
b) selection of the desired said message to be annotated; and,
c) addition of new handwritten stroke information message objects to said record.

35. The computer program product for messaging as claimed in claim 30, comprising computer readable program code for causing the computer to provide searching of said record based on user selected criteria.

36. A system for messaging within an interconnected network of computers comprising:
a) means for establishing a connection to a messaging service;
b) means for inputting handwritten stroke information message objects into a current message; and
c) means for transmitting said current message to said service, wherein said service keeps a record of all said current messages for distribution to, and handwritten stroke annotation by, users of said messaging service.

37. The system for messaging as claimed in claim 36, wherein:
said message objects are IM objects; and
said current message is an IM record.

38. The system for messaging as claimed in claim 36 further comprising means for copying a plurality of current messages from other applications.

39. The system for messaging as claimed in claim 36, further comprising means for forwarding said handwritten stroke information to at least one participant.

40. The system for messaging as claimed in claim 36, further comprising means for appending said handwritten stroke information onto an existing said record.

41. The system for messaging as claimed in claim 36, further comprising means for connecting, when initiated by a first of a plurality of users of said messaging service.

42. The system for messaging as claimed in claim 41, further comprising:
means for providing a graphical user interface to said user; and
means for including a handwritten stroke input field in said graphical user interface.

43. The system for messaging as claimed in claim 42, comprising means for providing an awareness field.

44. The system for messaging as claimed in claim 42, comprising means for inputting text.

45. The system for messaging as claimed in claim 44, comprising means for making said text a part of said message objects.

46. The system for messaging as claimed in claim 42, comprising means for making handwritten stroke information a part of said message objects.

47. The system for messaging as claimed in claim 42, comprising means for providing a recording field in said graphical user interface for login and displaying a complete history of said current messages.

48. The system for messaging as claimed in claim 47, comprising means for providing location information of an associated said message objects of any one of said current messages in said record.

49. The system for messaging as claimed in claim 48, comprising means for providing for each of said plurality of users, quick navigation through said recording field to said associated said message objects, whereby said associated said message objects are displayed to said each of said plurality of users.

50. The system for messaging as claimed in claim 49, comprising:
means for annotating of said messages in said recording field by any of said plurality of users;
means for alerting said plurality of users of said annotation.

51. The system for messaging as claimed in claim 50, comprising:
means for navigating to a user desired said message object of said record;
means for selecting the desired said message for annotation by said user; and
means for adding said new handwritten stroke information message objects to said record.

52. The system for messaging as claimed in claim 47, comprising means for search of said record based on user selected search criteria.

53. A method for messaging within an interconnected network of computers comprising:
establishing a connection to a messaging service;
inputting information message objects into a current message;
transmitting said current message to said messaging service, wherein said messaging service keeps a record of all said current messages for distribution to, and annotation by, users of said messaging service.

54. The method for messaging as claimed in claim 53, further comprising:
a. inputting said information message objects wherein said information comprises speech;
b. annotating said information message objects wherein said annotating comprises speech.

55. The method for messaging as claimed in claim 53, further comprising:
a. inputting said information message objects wherein said information comprises gestures;
b. annotating said information message objects wherein said annotating comprises gestures.
